(19) United States
(12) Patent Application Publication
(10) Pub. No.: US 2014/0351618 A1
(43) Pub. Date: Nov. 27, 2014

(54) Method and Electronic Device for Bringing a Primary Processor Out of Sleep Mode

(71) Applicant: Motorola Mobility LLC, Libertyville, IL (US)

(72) Inventors: Nathan M Connell, Hawthorn Woods, IL (US); Christian L. Flowers, Chicago, IL (US)

(73) Assignee: Motorola Mobility LLC, Libertyville, IL (US)

(21) Appl. No.: 14/048,190

(22) Filed: Oct. 8, 2013

Related U.S. Application Data
(60) Provisional application No. 61/827,746, filed on May 27, 2013.

(51) Int. Cl. G06F 1/32

(52) U.S. Cl. CPC G06F 1/3206
USPC 713/323

(57) ABSTRACT

A method is performed by an adjunct processor of a device for bringing a primary processor of the device out of a sleep mode. The method includes: monitoring for a set of inputs that indicates a likelihood of the primary processor being provided a primary awake command signal to awaken the primary processor from a sleep mode. The method further includes sending, by the adjunct processor to the primary processor upon receiving the set of inputs, an initial awake command signal to awaken the primary processor from the sleep mode.

### FIELD OF THE DISCLOSURE

The present disclosure relates generally to processor latency in an electronic device, and more particularly to a method and electronic device for bringing a primary processor of the device out of a sleep mode while hiding processor latency.

### BACKGROUND

When a user is not actively using an electronic device, the device can timeout and move into a sleep mode in an effort to preserve battery power. After the device is in the sleep mode, the user can take an explicit action that is directed at the device to cause the device to exit the sleep mode and to move into an active mode. When the device is in the active mode, the device can further respond to user input to perform requested functionality such as making a call or executing one or more applications such as text messaging or email. The time it takes for the device to move from sleep mode to the active mode is a latency time that is noticeable to a user. Moreover, when a user perceives the latency associated with bringing the device out of sleep mode, the user may associate the device with being a slow responding device or a problematic device. Accordingly, addressing this perceivable latency is desirable.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of some of those embodiments.

FIG. 1 illustrates a diagram of an electronic device in which embodiments of the present disclosure can be implemented for bringing a primary processor out of a sleep mode.

FIG. 2 is a flowchart illustrating a method of bringing a primary processor out of a sleep mode in accordance with an embodiment of the present disclosure.

FIG. 3 is a flowchart illustrating a method of bringing a primary processor out of sleep mode in accordance with an embodiment of the present disclosure.

FIG. 4 is a flowchart illustrating is an embodiment of a confidence process of a method of bringing a primary processor out of sleep mode in accordance with an embodiment of the present disclosure.

FIG. 5 is a flowchart illustrating several different embodiments of a confidence process of a method of bringing a primary processor out of sleep mode in accordance with an embodiment of the present disclosure.

FIG. 6 is a flowchart illustrating a method of bringing a primary processor out of sleep mode in accordance with an embodiment of the present disclosure.

FIG. 7 is a diagram illustrating a timeline and an embodiment of a primary processor awake sequence in accordance with an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the disclosure herein.

The electronic device and method components have been represented where appropriate by conventional symbols in the drawings, showing only those specific details that are pertinent to understanding the embodiments of the disclosure herein so as not to obscure the disclosure with details that will be readily apparent to those of ordinary skill in the art having the benefit of the description herein.

### DETAILED DESCRIPTION

Generally speaking, pursuant to the various embodiments, a method for bringing a primary processor of an electronic device (also referred to herein simply as a “device”) out of a sleep mode is performed by an adjunct processor of an electronic device. The adjunct processor monitors inputs from one or more components such as sensor or sensing components in the electronic device to determine whether a set of these inputs meets a confidence process. The set of inputs meeting the confidence process is interpreted by the device as indicating a likelihood of the device subsequently receiving an explicit request, command, or instruction to operate the device. When the set of inputs meets the confidence process, the adjunct processor sends the primary processor an initial (or early) awake command signal, which initiates a primary processor awake sequence. If a primary awake command signal (PACS) is thereafter received, which represents the explicit request, command, or instruction to operate the device, the primary processor completes its primary processor awake sequence.

In one example embodiment, a method is performed by an adjunct processor of a device for bringing a primary processor of the device out of a sleep mode. The method includes: monitoring for a set of inputs that indicates a likelihood of the primary processor being provided a primary awake command signal to awaken the primary processor from a sleep mode. The method further includes sending, by the adjunct processor to the primary processor upon receiving the set of inputs, an initial awake command signal to awaken the primary processor from the sleep mode.

In another embodiment, a method performed by a primary processor of a device for exiting from a sleep mode includes: receiving from an adjunct processor an initial awake command signal to awaken the primary processor from the sleep mode and initiating a primary processor awake sequence while monitoring for a primary awake command signal. The method further includes completing the primary processor awake sequence if the primary awake command signal is received.

In another example embodiment, an electronic device includes: a primary processor configured to receive at least one of a primary awake command signal or an initial awake command signal and to responsively initiate a primary processor awake sequence. The electronic device further includes an adjunct processor coupled to the primary processor and configured to monitor for a set of inputs that indicate a likelihood of the providing of the primary awake command signal, wherein the adjunct processor is further configured to send the initial awake command signal upon receiving the set of inputs.

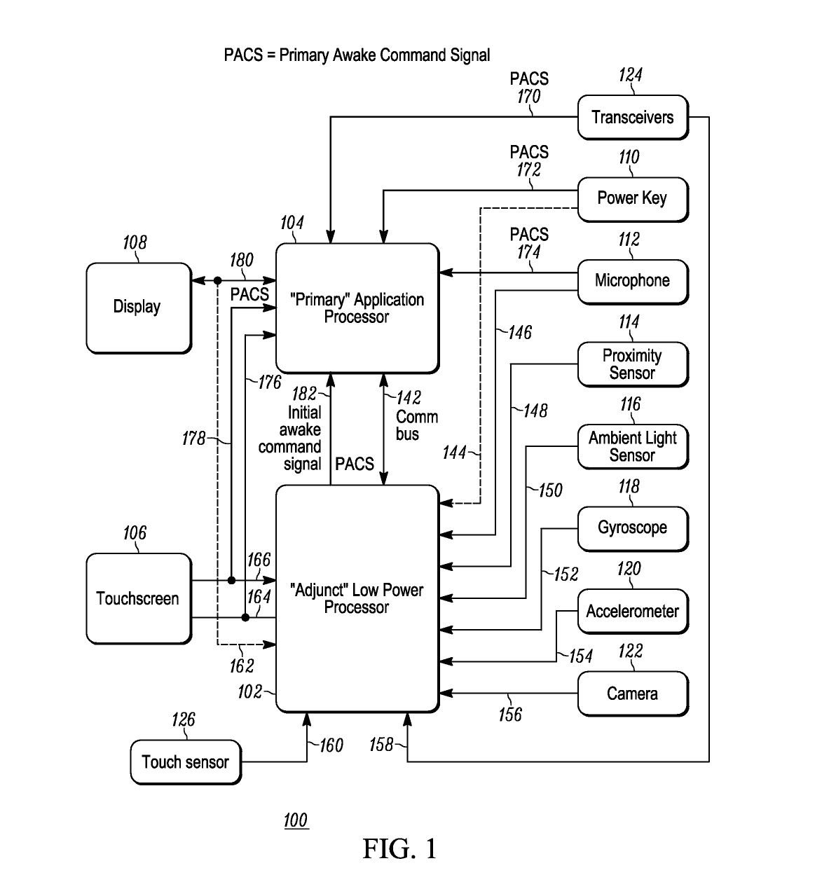

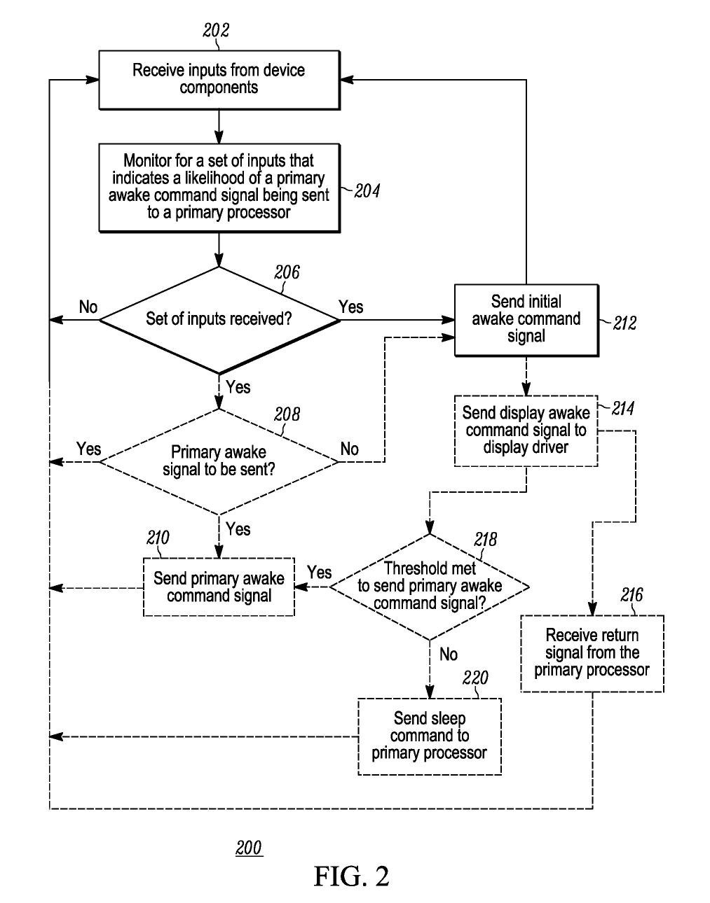

Referring now to the drawings, FIG. 1 illustrates an embodiment of an electronic device 100 for bringing a primary processor out of sleep mode in accordance with an embodiment of the present disclosure. The electronic device 100 includes an adjunct processor 102 and a primary processor 104 configured to perform methods, for instance methods illustrated by reference to the remaining FIGS. 2-7, in accordance with the present teachings. The electronic device 100 includes other device components such as: a touchscreen 106, a display 108, a power key 110, a microphone 112, a proximity sensor 114, an ambient light sensor 116, a gyroscope 118, an accelerometer 120, a camera 122, transceivers 124 including a cellular transceiver and at least one transceiver configured to connect to a peripheral device, and touch sensor 126 such as a perimeter touch sensor.

“Adapted,” “operative,” “capable” or “configured,” as used herein, means that the indicated elements or components are implemented using one or more hardware devices such as one or more operatively coupled processing cores, memory devices, and interfaces, which may or may not be programmed with software and/or firmware as the means for the indicated elements to implement their desired functionality. Such functionality of the adjunct processor 102 and the primary processor 104 is supported by the other hardware shown in FIG. 1.

Moreover, other components of the electronic device 100 are not shown in an effort to focus on the disclosed embodiments and to keep the detailed description to a practical length. Such other components include, but are not limited to, additional processors and memory components, transceivers such a Global Positioning System (GPS) transceiver, additional Input/Output (I/O) devices such as a mechanical keyboard and speakers, etc. Additionally, electronic device 100 may be implemented as any number of different types of electronic devices. These electronic devices include, by way of example, a laptop, a smartphone, a personal data assistant (PDA), a digital media player, a portable or mobile phone, a cellular phone, a personal wearable device, a tablet, a notebook computer such as a netbook, an eReader, and any other device having a primary processor and an adjunct processor, wherein the adjunct processor can be used to provide an early wakeup signal to the primary processor in accordance with the present teachings.

The display 108 is an optical display such as a liquid crystal display (LCD) that translates electrical signals representing a given image, which it receives over a link 180, to optical signals by which the image can be seen through optical effects. For example, each pixel of the image corresponds to a capacitor that is charged and slowly discharged to display the image on the display 108. The display 108 is coupled to the primary processor 104 using the link 180 and, in one particular and optional embodiment, may also be coupled to the adjunct processor using a link, e.g., a hardware coupling, 162. Using this topology, the display 108 is configured to receive a display awake command signal, from the primary processor 104 or the adjunct processor 102, to responsively initiate a display awake sequence. The display awake sequence is used to awaken the display 108 from a sleep mode to an active mode such that it is ready to display images thereon.

The touchscreen 106 provides a means for receiving tactile (or touch) input from a user's finger or some other input device such as a stylus. In a particular embodiment, the touchscreen 106 can operate in accordance with any suitable technology for sensing touch such as, by way of example, a resistive touchscreen or a capacitive touchscreen. The touchscreen 106 is coupled to the adjunct processor 102 using links 166 and 164 and to the primary processor 104 using links 178 and 176. In an embodiment, links 178 and 166 are communication interfaces such as communication busses for communicating data. Such data can indicate receipt of touch input on the touchscreen. In a further embodiment, links 176 and 164 are wire connections such as one or more pins used to communicate a signal such as an interrupt signal used to alert the processors 102 and 104 that touch has been sensed on the touchscreen 106. Although shown as separate components, the display 108 and touchscreen 106, in an alternative arrangement, are integrated into a single component.

The primary processor 104 provides main or core processing capabilities within the electronic device 100 and, in an embodiment, serves as an application processor. For example, the primary processor 104 is implemented as a system-on-chip (SoC) that supports word processing applications, email and text messaging applications, video and other image-related and/or multimedia applications, etc., executable on the electronic device 100. The adjunct processor 102 is a separate processor that, in an embodiment, handles peripheral or supportive processes for the primary processor 104. In a particular embodiment, the adjunct processor 102 supports processes that require less processing power than those performed by the primary processor 104 and is, thereby, also referred to herein as a lower or “low” power processor. For example, the adjunct processor 102 monitors input signals from one or more sensing components, for instance coupled to a sensor bus, in order to perform its functionality according to the present teachings.

The adjunct processor 102 and the primary processor 104 are configured to be coupled to each other over links 142 and 182. In an embodiment, link 142 is a communication bus interface that supports one or more standard or proprietary protocols for communicating data, control, and/or clock signals between the processors 102 and 104. In a particular embodiment, interface 142 is a bidirectional Mobile Industry Processor Interface (MIPI). MIPIs support numerous protocols including, but not limited to M-PHY, D-PHY, Display Serial Interface (DSI), MIPI Unified Protocol (UniPro), Low Latency Interface (LLI), SuperSpeed Inter-chip (SSIC), Camera Serial Interface (CSI), to name a few. As used herein, a MIPI is a chip-to-chip interface that conforms to standards created by the MIPI Alliance Standards Body, which standardizes interfaces for mobile applications.

In an embodiment, link 182 includes one or more wire connections, such as one or more pins, over which signals are sent. For example, one pin provides, supplies or sends an initial awake command signal, in accordance with the teachings herein, from the adjunct processor 102 to the primary processor 104 when the pin goes high (or, alternatively, low depending on the particular embodiment). In another embodiment, link 182 includes another pin that provides a primary awake command (PACS) signal from the adjunct processor 102 to the primary processor 104 when the pin goes high (or, alternatively, low).

A primary awake command signal is a signal provided to initiate a primary processor awake sequence to transition or awaken the primary processor 104 from a sleep mode in order to operate in an active mode to support its normal functionality. The primary awake command signal is sent in response to, and is thereby associated with, an explicit request, command, or instruction to operate the electronic device 100. Such a request results from certain events such as those described below.

The component providing the primary awake command signal is referred to herein as an “awakening component.” Accordingly, in the embodiment shown, the following example components can serve as the awakening component to directly provide the primary awake command signal to the primary processor 104 over a link in response to the following associated events: the cellular transceiver 124 over a link 170, for instance in response to receiving a call; the power key 110 over a link 172 in response to a user depressing the power key 110; the microphone 112 over a link 174 in response to receiving a voice command; and the touchscreen 106 over the link 178 in response to receiving tactile (or touch) input, e.g., the entering of an alphanumeric passcode and/or a swipe sequence or gesture, etc. As such, the primary awake command signal is provided in response to at least one of a depressed power key, an audio awake command, an incoming call, or an input sequence on the touchscreen 106.

In another embodiment, the adjunct processor 102 is coupled to the touchscreen 106 over the link 166, to the power key 110 over a link 144, to the microphone 112 over a link 146, and to the cellular transceiver 124 over a link 158 to receive indication of the aforementioned events. Correspondingly, the adjunct processor 102 is configured to responsively provide the primary awake command signal to the primary processor 104 over the link 182.

The initial awake command signal is a signal that is sent in response to the adjunct processor 102 interpreting a set of, meaning one or more, received inputs as meeting one or more confidence processes. The confidence process(es) are used to determine a likelihood that a primary awake command signal will be subsequently provided to the primary processor 104. In accordance with at least some implementation scenarios, in essence the initial awake command signal provides an “early” awake command signal to the primary processor 104, wherein early means that the initial awake command signal is sent prior to the primary processor 104 receiving the primary awake command signal. This early awakening of the primary processor before an explicit request to operate the electronic device 100 serves to hide from a user of the device 100 at least a portion or at least some of the latency associated with the primary processor awake sequence.

The device components that provide the inputs to the adjunct processor 102 for determining whether to awaken the primary processor 104 using the initial awake command signal are referred to herein as sensor or sensing components. The sensing components include, but are not necessarily limited to, one or more of: the touchscreen 106, the accelerometer 120, the proximity sensor 114, the ambient light sensor 116, the gyroscope 118, the microphone 112, the touch sensor 126, a transceiver 124 configured to connect to a peripheral device such as a headset or speaker, or the camera 122, each coupled to the adjunct processor 102 and each configured to provide an input included within the set of inputs to indicate the likelihood of the providing of the primary awake command signal.

The transceiver 124 is coupled to the adjunct processor 102 using the link 158. The microphone 112 is coupled to the adjunct processor 102 using the link 146. The proximity sensor 114 is coupled to the adjunct processor 102 using a link 148. The ambient light sensor 116 is coupled to the adjunct processor 102 using a link 150. The gyroscope 118 is coupled to the adjunct processor using a link 152. The accelerometer 120 is coupled to the adjunct processor using a link 154. The camera 122 is coupled to the adjunct processor using a link 156. The touch sensor 126 is coupled to the adjunct processor 102 using a link 160. The touchscreen 106 provides indications of tactile input sequences, gestures, and/or patterns to the adjunct processor 102 using the link 166. Using this configuration, the sensing components detect one or more of: user voice or touch input; status such as position, speed, angle, etc., of the device 100; ambient sounds and objects within the environment surrounding the device 100; other devices wirelessly connected to the adjunct processor 102 using a proprietary or standard (e.g., Bluetooth, 802.11, etc.) protocol; objects such as a user's hand or finger, a stylus, or a table, car seat or other surface physically contacting the device 100; objects within the vicinity of or near the device 100; whether the device 100 is in an enclosed space such as a car, purse, or pocket, etc.

The remaining FIGS. 2-7 illustrate example methods in accordance with the present disclosure to awaken a primary processor, e.g., 104, from a sleep mode while desirably hiding latency of the primary processor 104 and in some embodiments of the display 108 from a user of the device 100 when these components transition between the sleep mode and an active mode. Particularly, FIG. 2 illustrates a method 200 performed by an adjunct processor such as the adjunct processor 102. In accordance with the method 200, the adjunct processor 102 receives 202 inputs from sensing components, which can include one or more of the sensing components described above. The adjunct processor 102 monitors 204 for a set of the received inputs that indicates a likelihood of a primary awake command signal being sent to the primary processor 104.

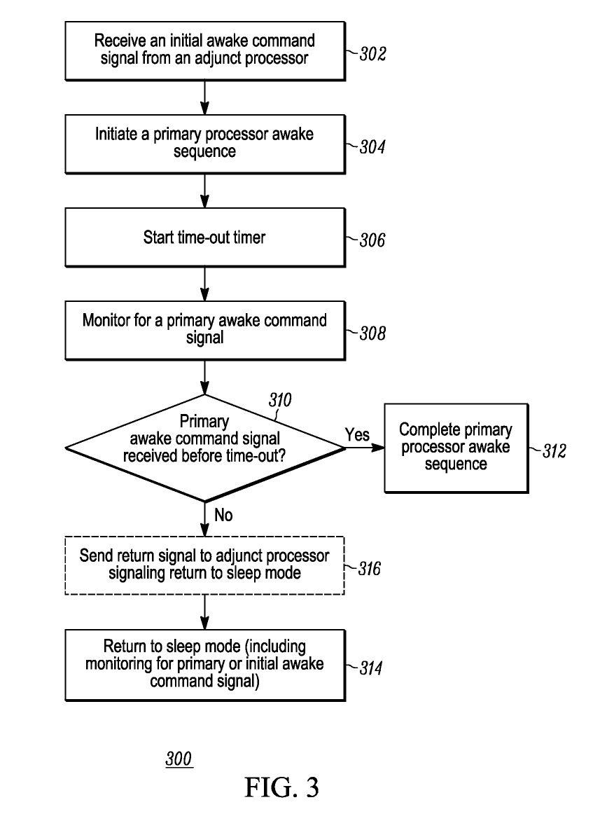

Such a likelihood is determined by the adjunct processor 102 analyzing 206 the inputs received at 202 with respect to or in view of one or more confidence processes. Where the inputs received at 202 do not meet any confidence process, the adjunct processor 102 continues to receive 202 and monitor 204 the inputs. Where the inputs received at 202 satisfy 206 at least one confidence process, the adjunct processor 102 sends 212 an initial awake command signal to the primary processor 104 to awaken the primary processor from the sleep mode. Upon receiving the initial awake command signal, the primary processor 104 begins a primary processor awake sequence, which is described in more detail later by reference to FIGS. 3, 6, and 7.

Other optional embodiments can be realized by the adjunct processor 102 in accordance with the remaining functionality shown by reference to FIG. 2. For example, by reference to functional blocks 202, 204, 206, and 212, the adjunct processor 102 may be configured to send 212 the initial awake command signal without confirming 208 whether or not the primary awake command signal is to be sent, i.e., wherein at least one event has already occurred that triggers the sending of the primary awake command signal.

Accordingly, in a first optional embodiment, prior to sending 212 the initial awake command signal, the adjunct processor 102 first determines 208 whether there is an indication that a primary awake command signal is to be or should be sent to the primary processor 104. This determination is implemented, for instance, by an awakening component such as the cellular transceiver 124, the power key 110, the microphone 112, or the touchscreen 106 indicating through any suitable signal or messaging over the respective links 158, 144, 146, and 166 that the awakening component has sent or is sending a primary awake command signal to the primary processor 104. Where there is no indication of the primary awake command signal, the adjunct processor proceeds to send 212 the initial awake command signal. Alternatively, based on signaling or messaging from these components indicating a qualifying event, the adjunct processor 102 sends 210 the primary awake command signal to the primary processor 104. In either case, since the primary awake command signal has been or is in the process of being sent, the adjunct processor 102 withholds sending the initial awake command signal. The adjunct processor 102 instead returns to receiving 202 the inputs from the sensing components and monitoring 204 for the set of inputs that meet a confidence process for sending the initial awake command signal.

In a further optional embodiment, after sending 212 the initial awake command signal, the adjunct processor 102 substantially concurrently sends 214 a display awake command signal over its direct link 162 to the display 108, to awaken the display 108 from a sleep mode. As a consequence of this embodiment, both the display 108 and the primary processor 104 perform their corresponding awake sequences in parallel. This further minimizes the chance of a user experiencing the latency associated with either of these components transitioning from a sleep state to an active state, when the user wishes to operate the device 100. Alternatively, the initial awake command signal further indicates to the primary processor 104 to send the display awake command signal to the display 108 of the device 100 to awaken the display 108 from the display sleep mode. In this embodiment, the display awake sequence could be performed subsequent to primary processor awake sequence.

Under one particular operational scenario after sending 212 the initial awake command signal, an event fails to occur, which would trigger the sending of the primary awake command signal. In such as case, the primary processor 104 returns to the sleep mode. Optionally, the primary processor further provides an indication of its return to the sleep mode in a return signal to the adjunct processor 102. Accordingly, in this embodiment, the adjunct processor 102 receives 216 a return signal from the primary processor 104 after sending 212 the initial awake command signal, wherein the return signal indicates that the primary processor 104 is returning to the sleep mode. The adjunct processor 102 thereafter immediately returns to receiving 202 and monitoring 204 inputs from the sensing components.

In a further optional embodiment, upon sending 212 the initial awake command signal, the adjunct processor 102 performs monitoring 218 to determine whether an event, also referred to herein as a threshold, has occurred that would trigger the sending of the primary awake command signal. For example, through its respective links 158, 144, 146, and/or 166, with the transceiver 124, the power key 110, the microphone 112, and/or the touchscreen 106, the adjunct processor 102 determines whether a call has been received, the power key has been depressed, a triggering voice command has been provided, and/or a triggering gesture has been input. If the threshold has been met through the occurrence of any one or more of such events, for instance, the adjunct processor 102 proceeds to send 210 the primary awake command signal to the primary processor 104. Otherwise, the adjunct processor 102 sends 220 a sleep command signal to the primary processor 104 to return the primary processor 104 to the sleep mode and then returns to receiving 202 and monitoring 204 the inputs.

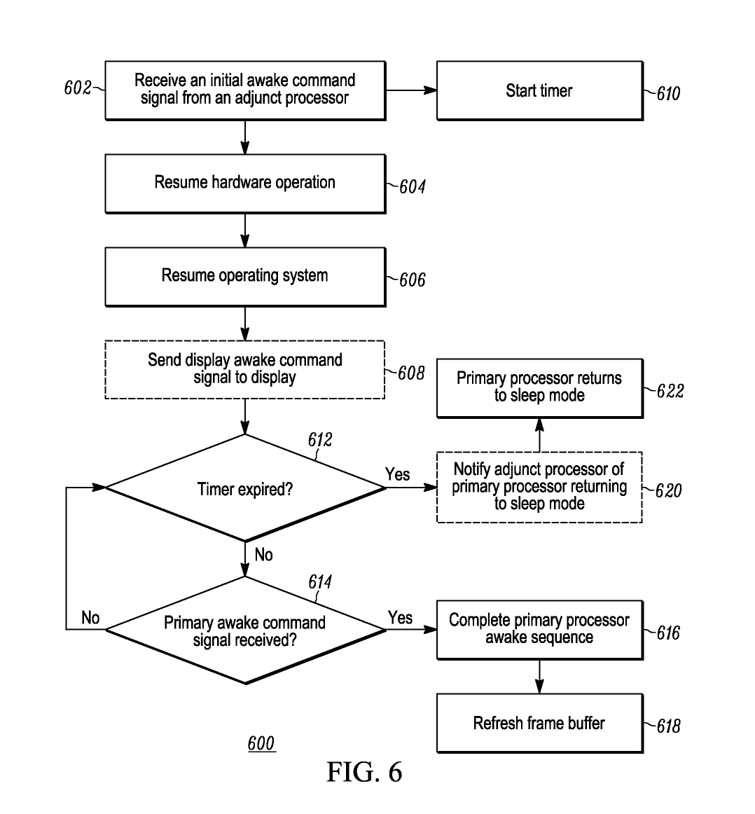

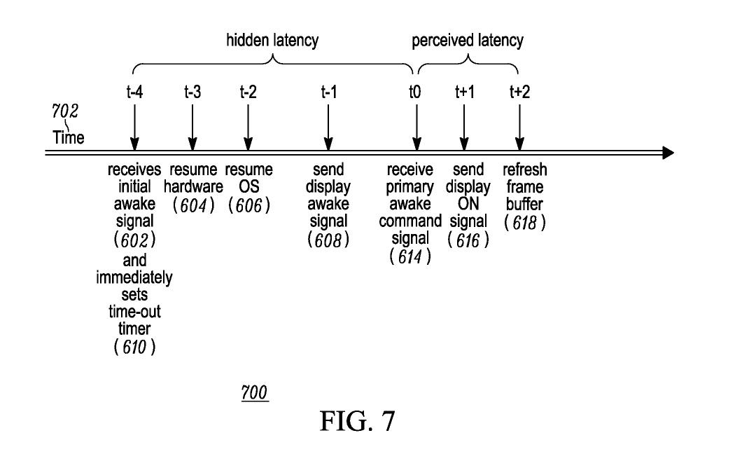

Turning to FIG. 3, an embodiment illustrates a general method 300 performed by a primary processor of a device, such as the primary processor 104 of the device 100 for exiting from a sleep mode. At 302, the primary processor receives the initial awake command signal from an adjunct processor, e.g., 102. Responsively, the primary processor 104 initiates 304 a primary processor awake sequence, for instance as described in further detail below by reference to FIGS. 6 and 7, while monitoring 308 for a primary awake command signal. Particularly, the primary processor 104 starts 306 a time-out timer. The timer value depends, for instance, upon experiential data as to a typical time that the device 100 could expect an event to occur that triggers the sending of the primary awake command signal. The monitoring 308 involves the primary processor 104 determining 310 whether it has received a primary awake command signal before the time-out timer expires. When the primary awake command signal is received prior to the time-out expiration, the primary processor 104 completes 312 its primary processor awake sequence.

Where, instead, the primary processor 104 fails to receive the primary awake command signal prior to the time-out timer expiring, the primary processor 104 returns 314 to the sleep mode, wherein the primary processor 104 monitors for a primary or initial awake command signal. In a particular optional embodiment of the method 300, as touched on above, the primary processor 104 also sends 316 a return signal to the adjunct processor 102 signaling its return to the sleep mode.

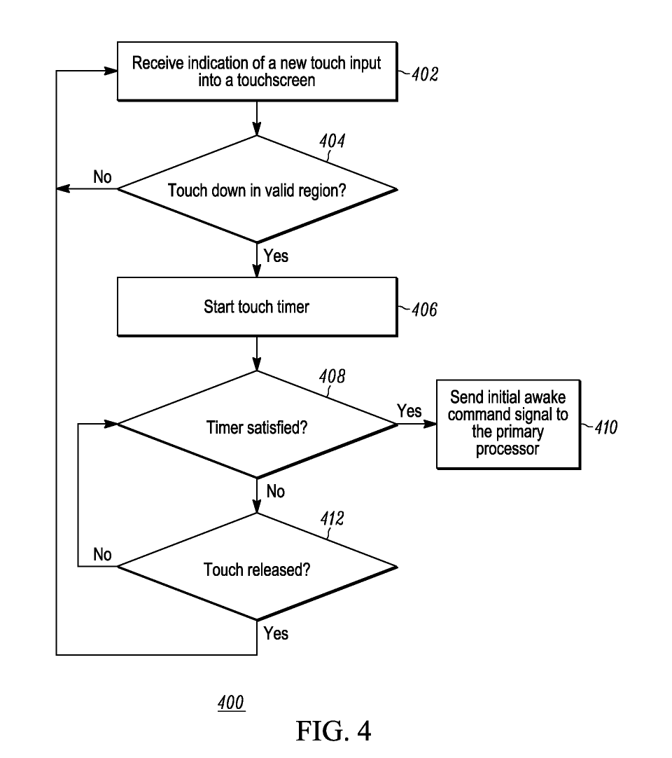

As stated above, there are numerous embodiments of a set of inputs that indicates a likelihood of the primary processor being provided a primary awake command signal. FIG. 4 illustrates a confidence process 400 performed by an adjunct processor, e.g., 102, where the touchscreen 108 sends over the link 166 the set of inputs that satisfies the confidence process 400. Satisfying or meeting a confidence process results in the adjunct processor 102 sending the initial awake command signal to the primary processor 104. Accordingly, in this embodiment, the set of inputs, which indicates the likelihood of the providing of the primary awake command signal, is provided in response to an input sequence onto the touchscreen 106. In this case, the input sequence comprises a touch input on a first area of the touchscreen 106 for a duration of a first timer.

More particularly, at 402, the adjunct processor 102 receives an indication of a new touch input onto a touchscreen 106, such as through an interrupt signal over the pin 164. Responsively, the adjunct processor 102 monitors 404 data on the link 166, wherein the data represents the particular current incoming touch sequence on the touchscreen 106. For example, the monitoring 404 involves setting 406 a touch timer and determining 404 whether the touch is in a valid region for the duration of the timer value. If the touch is in a valid region for the duration of the touch timer, the timer is determined 408 to be satisfied. Therefore, the adjunct processor 102 responsively sends 410 the initial awake command signal to the primary processor 104. If the touch is not continuous during the duration of the touch timer, the touch is determined 412 to be released, and the confidence process 400 is, thereby, not satisfied. Accordingly, the adjunct processor 102 continues monitoring 402 for a new touch input.

In one example implementation scenario, a virtual bar is presented as a graphical user interface on the touchscreen. In order for the touchscreen 106 to generate on output that corresponds to sending a primary awake command signal, the user must input a predetermined gesture such as a sliding gesture across some length of the virtual bar. In such a scenario, the adjunct processor 102 could determine that the confidence process 400 is satisfied upon receiving an indication from the touchscreen 106 that the user has touched the virtual bar for the duration of the touch timer. Alternatively, the adjunct processor 102 could determine that the confidence process 400 is satisfied upon receiving an indication from the touchscreen 106 that the user has input a swipe gesture across the bar for a length of time that satisfies the touch timer. In an embodiment, the length of the touch timer is shorter than a length of time required for the gesture that is needed to trigger the sending of the primary awake command signal.

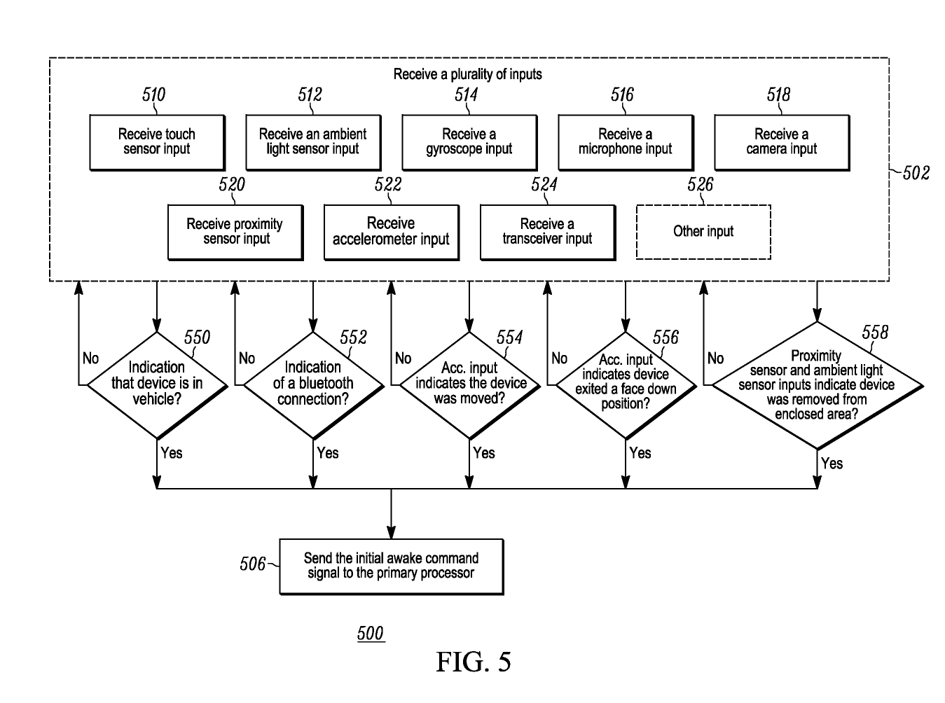

Other embodiments of confidence processes, performed by the adjunct processor, e.g., 102, that may trigger the adjunct processor 102 to send the initial awake command signal are illustrated by reference to a method 500 shown in FIG. 5. Particularly, the adjunct processor 102 receives 502 a plurality of inputs from sensing components of an electronic device. The adjunct processor 102 determines 550-558 whether within these plurality of inputs is included a set of inputs, which indicates the likelihood of the providing of the primary awake command signal. Where the device is configured and arranged as the device 100 illustrated in FIG. 1, the adjunct processor 102 receives 502 one or more of: 522, an accelerometer input; 520, a proximity sensor input; 512, an ambient light sensor input; 514, a gyroscope input; 516, a microphone input; 518, a camera input; a 510 touch sensor input; or, 524, at least one input from a transceiver configured to create a connection to a peripheral device. Any other suitable input 526 can be received into the adjunct processor 102 to determine whether a confidence process is satisfied, which indicates the likelihood of the providing of the primary awake command signal.

Functional decision blocks 550-558 represent example confidence processes that may be satisfied by one of or a combination of the inputs 510-526. Namely, in an embodiment, the device has stored therein code that represents an algorithm for executing the confidence processes 550-558. Moreover, the device has stored therein data such as in the form of tables and/or databases with which to compare the received inputs 510-526 to determine whether one or more of confidence processes 550-558 is satisfied. Where any of the confidence processes 550-558 is met, the adjunct processor 102 sends 506 the initial awake command sequence to the primary processor 104.

In accordance with one example confidence process, the adjunct processor 102 determines 550 if the device is in a vehicle such as a car or train or is in some other enclosed space such as a purse or pocket. Thus, in this embodiment, the set of inputs, which indicates the likelihood of the providing of the primary awake command signal, indicates that the device is in a car or other enclosed environment. For example, received inputs 510 and 520 from sensing components such as the proximity sensor 114 and the touch sensor 126 could be used to determine the closeness of the device to one or more objects and/or whether the device is touching the object(s). The adjunct processor 102 could use the received input 512 from the ambient light sensor 116 to determine whether the device is in a dark space such as a purse or pocket. The adjunct processor 102 could use received inputs 518 and 516 from the camera 122 and the microphone 112, respectively, to detect sights and sounds in the environment to qualify and type the environment as a known environment, etc.

In accordance with another example confidence process, the adjunct processor 102 determines 552 whether the device has established a wireless connection, such as a Bluetooth connection in one example implementation, with another device. In this embodiment, the set of inputs, which indicates the likelihood of the providing of the primary awake command signal, indicates the device wirelessly connecting to a peripheral device. The adjunct processor 102 can use a received input 524 from a transceiver 124 that has established a wireless connection to a peripheral device (such as a headset or a speaker) to make such a determination.

In accordance with yet another example confidence process, the adjunct processor 102 determines 554 whether the device was moved. In an embodiment, the set of inputs, which indicates the likelihood of the providing of the primary awake command signal, includes the received 522 accelerometer input (acc.input) indicating that the device has changed from motionless to moving. In accordance with another example confidence process, the adjunct processor 102 determines 556 whether a particular instance of movement of the device has occurred. Particularly, the set of inputs, which indicates the likelihood of the providing of the primary awake command signal, includes the received 522 accelerometer input indicating that the device is exiting from a face down position, for instance, to a face up or substantially face up position. In another example confidence process, the adjunct processor 102 determines 558 if the device was removed from an enclosed area. In a particular embodiment, the set of inputs, which indicates the likelihood of the providing of the primary awake command signal, includes the received 512 and 520 proximity sensor and ambient light sensor inputs indicating that the device was removed from an enclosed area.

Turning now to FIG. 6, shown therein is a flowchart illustrating a method 600 of bringing a primary processor, e.g., 104, out of sleep mode in accordance with an embodiment of the present disclosure. Method 600 also illustrates an example primary processor awake sequence. FIG. 7 illustrates a timeline 700 showing occurrence of the functions that make up method 600 along a time axis 702, for instance in milliseconds. FIGS. 6 and 7 are described together for further clarity. Accordingly, at 602, the primary processor 104 receives an initial awake command signal from an adjunct processor, e.g., 102. The primary processor 104 immediately or substantially immediately, responsively, starts 610 a timer and initiates a primary processor awake sequence. Functions 602 and 610 are shown as occurring at a time t−4 along the time axis 702. The primary processor awake sequence includes resuming 604 the hardware of the primary processor 104 at a time t−3 and resuming 606 the operating system of the primary processor 104 at a time t−2.

As described above, the initial awake command signal may also instruct the primary processor 104 to send 608 a display awake command signal to the display 108, which is done at a time t−1, as part of the primary processor awake sequence. The display awake command signal causes the display 108 to initiate the display awake sequence including, for instance, resuming the hardware of the display. The primary processor 104 then determines 614 whether it received a primary awake command signal before the timer expires, at 612. Where the primary awake command signal is received 614 prior to the timer expiration, represented by a time t0 on the time axis 702, the primary processor completes 616 primary processor awake sequence.

In an embodiment, completing the primary processor 104 awake sequence includes the primary processor sending to the display 108, at a time t+1 on the time axis 702, a display ON command signal to command the display 108 to complete the display awake sequence for instance by lighting up the display. Upon completing the primary processor awake sequence, the primary processor 104 refreshes 618 its frame buffer by writing a frame to a memory component such a Random Access Memory, at a time t+2 as shown on the time axis 702.

Where the primary processor 104 receives the primary awake command signal at a point in the primary processor awake sequence, as shown in FIG. 7, a maximum hidden latency of the time difference between t0 and t−4 is achieved. Correspondingly, the latency perceivable to a user of the device is represented by the time difference between t+2 and t0. Where the primary awake command signal is received earlier in the primary processor awake sequence, a shorter hidden latency is achieved, depending on the timing of such receipt. This results in a longer perceivable latency to the user. However, in many implementation scenarios, this longer perceivable latency is still shorter than is achievable using conventional technology.

Turning back to method 600, where the primary processor 104 fails to receive the primary awake command signal within the allotted time frame, the primary processor returns 622 to the sleep mode. Optionally, as described above, the primary processor 104 notifies 620 the adjunct processor that it is returning to the sleep mode.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The term “set” includes one or more. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage medium having computer readable code stored thereon for programming a computer (e.g., including a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method performed by an adjunct processor of a device for bringing a primary processor of the device out of a sleep mode, the method comprising:
monitoring for a set of inputs that indicates a likelihood of the primary processor being provided a primary awake command signal to awaken the primary processor from a sleep mode;
sending, by the adjunct processor to the primary processor upon receiving the set of inputs, an initial awake command signal to awaken the primary processor from the sleep mode.

2. The method of claim 1, wherein the initial awake command signal is sent prior to the primary processor receiving the primary awake command signal.

3. The method of claim 1, wherein the adjunct processor is configured to provide the primary awake command signal to the primary processor, the method further comprising:
determining that a threshold for sending the primary awake command signal was not met;
sending a sleep command signal to the primary processor to return the primary processor to the sleep mode.

4. The method of claim 1 further comprising receiving a return signal from the primary processor after sending the initial awake command signal, wherein the return signal indicates that the primary processor is returning to the sleep mode.

5. The method of claim 1, wherein the primary awake command signal is provided in response to at least one of a depressed power key, an audio awake command, an incoming call, or an input sequence on a touchscreen.

6. The method of claim 1, wherein the set of inputs, which indicates the likelihood of the providing of the primary awake command signal, is provided in response to an input sequence onto the touchscreen.

7. The method of claim 6, wherein the input sequence comprises a touch input on a first area of the touchscreen for a duration of a first timer.

8. The method of claim 1, wherein the initial awake command signal indicates to the primary processor to send a display awake command signal to a display of the device to awaken the display from a display sleep mode.

9. The method of claim 1 further comprising the adjunct processor sending a display awake command signal to a display of the device to awaken the display from a display sleep mode.

10. The method of claim 1, wherein the set of inputs, which indicates the likelihood of the providing of the primary awake command signal, comprises at least one of: an accelerometer input, a proximity sensor input, an ambient light sensor input, a gyroscope input, a microphone input, a camera input, a touch sensor input, or at least one input from a transceiver configured to create a connection to a peripheral device.

11. The method of claim 10, wherein the set of inputs comprises the proximity sensor input and the ambient light sensor input indicating that the device was removed from an enclosed area.

12. The method of claim 10, wherein the set of inputs comprises the accelerometer input indicating that the device is exiting from a face down position.

13. The method of claim 10, wherein the set of inputs comprises the accelerometer input indicating that the device has changed from motionless to moving.

14. A method of claim 10, wherein the set of inputs, which indicates the likelihood of the providing of the primary awake command signal, further indicates at least one of:
the device wirelessly connecting to a peripheral device; or that the device is in a vehicle.

15. A method performed by a primary processor of a device for exiting from a sleep mode, the method comprising:
receiving from an adjunct processor an initial awake command signal to awaken the primary processor from the sleep mode;
initiating a primary processor awake sequence while monitoring for a primary awake command signal;
completing the primary processor awake sequence if the primary awake command signal is received.

16. The method of claim 15 further comprising, upon failing to receive the primary awake command signal, returning to the sleep mode.

17. The method of claim 15, wherein the primary processor awake sequence comprises the primary processor sending a display awake command signal to a display of the device to initiate a display awake sequence, and wherein completing the primary processor awake sequence comprises the primary processor sending to the display a display ON command signal to command the display to complete the display awake sequence.

18. An electronic device comprising:
a primary processor configured to receive at least one of a primary awake command signal or an initial awake command signal and to responsively initiate a primary processor awake sequence;
an adjunct processor coupled to the primary processor and configured to monitor for a set of inputs that indicate a likelihood of the providing of the primary awake command signal, wherein the adjunct processor is further configured to send the initial awake command signal upon receiving the set of inputs.

19. The electronic device of claim 18 further comprising:
a display configured to receive a display awake command signal and to responsively initiate a display awake sequence;
a hardware coupling between the adjunct processor and the display for communicating the display awake command signal.

20. The electronic device of claim 18 further comprising at least one of: a touchscreen, an accelerometer, a proximity sensor, an ambient light sensor, a gyroscope, a microphone, a touch sensor, a transceiver configured to connect to a peripheral device, or a camera, each coupled to the adjunct processor and each configured to provide an input included within the set of inputs to indicate the likelihood of the providing of the primary awake command signal.
